(19) United States
(12) Patent Application Publication
(10) Pub. No.: US 2011/0057151 A1
(43) Pub. Date: Mar. 10, 2011

(54) IONIC SALT COMBINATIONS IN POLYMER ELECTROLUMINESCENT INKS

(75) Inventors: Jian Ping Chen, Sunnyvale, CA (US); John Devin MacKenzie, Los Gatos, CA (US)

(73) Assignee: Add-Vision, Inc., Scotts Valley, CA (US)

(21) Appl. No.: 12/557,316

(22) Filed: Sep. 10, 2009

(51) Int. Cl. C09D 11/10; C09K 11/06

(52) U.S. Cl. 252/301.35

(57) ABSTRACT

Luminescent ink formulations containing multiple salts selected for good ionic mobility, thermal stability, compatibility with light emitting polymers, good solubility in ink solvents, and electrochemical stability improve the performance of electroluminescent ink. As one salt may not contain all the required properties, a combination of salts is chosen based on the physical and chemical properties of different salts. When multiple salts are incorporated into a light emitting polymer layer, devices show improved lifetime and overall device performance.

### FIELD OF THE INVENTION

This invention relates to electrically active (e.g. conjugated) polymer-containing compositions and their use in emissive (i.e. light emitting) devices and displays. More specifically, this invention relates to the manufacturing method, namely printing, used to produce polymer light emitting devices, and a method and compositions to improve the polymer-containing ink for the screen printing process. Through the use of a combination of salt additives, a polymer-based electroluminescent ink is formulated that improves printability, electroluminescence uniformity, operating voltage and lifetime.

### BACKGROUND

Electroluminescent polymers are materials that emit light when sandwiched between two suitable electrodes and when a sufficient voltage is applied. A number of electroluminescent devices have been disclosed which use organic materials as an active light-emitting layer sandwiched between two electrodes. For example, VanSlyke et al. in U.S. Pat. No. 4,539,507 disclose a device having a bilayer of two vacuum-sublimed films of small organic molecules sandwiched between two contacts. The small organic molecules however are not printable using a solution-based process. In a related patent, Friend et al. in U.S. Pat. No. 5,247,190, disclosed a device having a thin dense polymer film made up of at least one conjugated polymer sandwiched between two electrodes. Subsequently, Braun at al. in U.S. Pat. No. 5,408,109 showed that high brightness light emitting devices could be made using soluble electroluminescent polymers. Their results indicated that it may be possible to make light emitting displays using inexpensive solution-based atmospheric processing techniques, such as ink-jet printing, reel-to-reel or screen printing. However, efficient device operation required the use of low work-function metals, such as calcium, that are not stable under atmospheric processing (i.e. printing) conditions.

Pei et al. describe a polymer light-emitting electrochemical cell (U.S. Pat. No. 5,682,043) that contains a solid state electrolyte and salt that is used to electrochemically dope an organic electroluminescent layer, such as a conjugated polymer, via ionic transport. This system provides the ability to achieve efficient device operation without relying on the use of low work-function metals. Following this work, Cao showed in U.S. Pat. Nos. 5,965,281 and 6,284,435 that organic anionic surfactants cause a similar effect without needing ionic transport through the polymer film. The patents described in this paragraph disclose many anions and cations that are useful in the present invention, and their disclosures are incorporated herein by reference. In theory, electrochemical doping or anionic surfactants could be used to make a electroluminescent polymer device that would be fully compatible with liquid-based processing under atmospheric conditions. Nonetheless, the electroluminescent polymer solutions discussed in these patents are not easy applicable to many fully liquid-based manufacturing processes, such as screen printing and gravure, and also have limited lifetimes.

Screen printing is one of the most promising methods to inexpensively manufacture large-area electroluminescent displays. Screen printing has been successfully applied to manufacturing large area inorganic phosphor-based electroluminescent displays by Topp et al. in U.S. Pat. No. 4,665,342. Victor et al. showed that screen printing can also be used to manufacture polymer-based electroluminescent displays (U.S. Pat. No. 7,115,216) using a fully printable cathode. Carter et al. (U.S. Pat. No. 6,605,483) revealed a method to make a printable electroluminescent ink that improves the screen printability and performance of electroluminescent polymer solutions through the use of soluble or dispersible additives, such as gel retarders, high boiling point solvents, and ionic dopants. Nonetheless, these inks still suffer form slow turn-on, lower lifetimes and higher operating voltage when fully printed.

### SUMMARY OF THE INVENTION

There is a need for printable polymer luminescent inks with fast switching speed and long lifetimes. Several factors limit lifetime, including ionic overdoping of the conjugated light emitting polymer, poor interface between either electrode and light emitting polymer layer, and phase separation between light emitting polymer and electrolyte. Furthermore, unbalanced doping profiles can lead to electron/hole imbalances and poor quantum efficiency, and can move the light emission zone towards quenching sites near the device electrodes. Therefore, improved electrochemically stable ionic dopants or salts that can effectively balance the doping profiles are needed. However, salts that may be optimal for controlling the doping profile may not be sufficiently mobile to enable fast turn on, and salts that may enable fast turn on may not be sufficiently compatible with the polymer to reduce phase separation. A mixture of salts selected to provide different characteristics provides the ability to tune each property needed to optimize the device properties. Previous work on light emitting polymer devices has utilized mixed anions containing triflate-groups, but with poor lifetime performance. Pei et al. claim mixtures of different salts but do not recognize that salt mixtures can be tuned to optimize device properties. Here we demonstrate improved lifetime with careful selection of mixed cations and anions taken from groups with different ionic character.

The present invention uses novel luminescent ink formulations containing multiple salts to improve the performance of electroluminescent ink. The multiple salt mixture needs salts with good ionic mobility, thermal stability, compatibility with light emitting polymers, good solubility in ink solvents, and electrochemical stability. As one salt may not contain all the required properties, a combination of salts is chosen based on the physical and chemical properties of different salts, such as their ionic mobility or electrochemical stability. Furthermore, salts with aromatic groups are selected to have better compatibility with light emitting polymers. Different salt combinations are used for electroluminescent ink formulation and fully screen-printed devices are made from these ink formulations. Experimental results show that when multiple salts are incorporated into a light emitting polymer layer, devices show improved lifetime and overall device performance.

### BRIEF DESCRIPTION OF DRAWINGS

FIG. 1 shows a simplified polymer electroluminescent device;

FIG. 2 shows device performance for a single salt ink;

FIG. 3 shows device performance for a binary salt combination ink;

FIG. 4 shows device performance for a second binary salt combination ink;

FIG. 5 shows device performance for a ternary salt combination ink;

FIG. 6 shows device performance for a quaternary salt combination ink; and

FIG. 7 shows structures of salts used in the ink formulations of the examples.

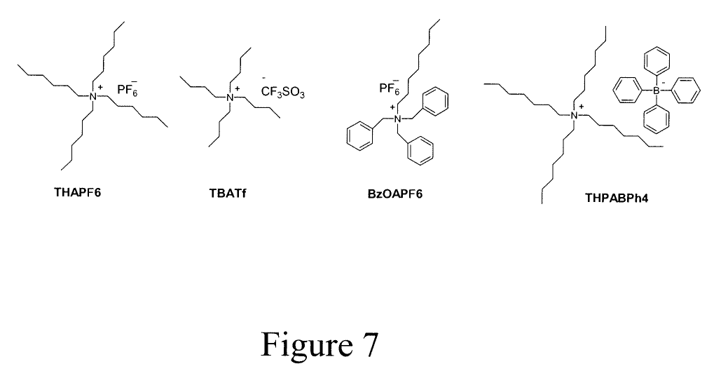

### DETAILED DESCRIPTION

An electroluminescent polymer solution is defined to include a soluble electroluminescent (conjugated) polymer that is mixed at 0.3% to 5% by weight into solution with an appropriate solvent. An example involves mixing 0.8% of Merck Super Yellow into an organic solvent, such as m-xylene and chlorobenzene, to form an electroluminescent polymer solution. Examples of the electroluminescent conjugated polymers include polyfluorenes, polyphenylene vinylenes, polyphenylene ethynylenes, polyvinyl carbazole, polythiophenes, polyphenylenes, polyanthracenes, and polyspiro compounds. Examples of solvents include o-xylene, m-xylene, p-xylene, chlorobenzene, dichlorobenzene, toluene, anisole, cyclohexanone, cyclopentanone, cumene, tetrahydrofuran, dioxane, methyl benzoate, methyl anisole, acetonitorile, chloroform, trichlorobenzene, dimethylformamide, dimethylsufoxide, and N-methylpyrrolidone. Electroluminescent polymers can be added to a mixture of solvents.

A printable electroluminescent polymer ink is defined to include a mixture of the electroluminescent polymer solution that may include other (non-emissive) polymers and multiple ionic surfactants and/or salts. Typical values for the ionic salt are a ratio of 1% to 10% of the ionic salt by weight of the electroluminescent polymer. Typical values for the non-electroluminescent polymer are a molecular weight between 50,000 and 10,000,000 added into the electroluminescent polymer solution in a ratio of 2% to 100% by weight of the electroluminescent polymer, depending on the relative solubility and molecular weights. Examples of the other polymer additives and preferred salts are given below, as are examples of screen printable electroluminescent polymer inks and resulting device properties. Derivatives of these inks have been demonstrated to produce high performance gravure printable and coatable light emitting polymer (LEP) inks. The present invention also applies to bar coating, gravure printing, spray coating, flexo printing, die coating, slot coating, ink jet printing and other deposition and printing techniques.

Addition of non-electroluminescent polymers of various molecular weights to the electroluminescent polymer solution may be used to increase the viscosity of the polymer solution or to improve ionic conductivity. Solutions that have too low viscosity can run, or bleed, through printing screens, resulting in blurred edges due to ink flow on substrates and print surfaces, loss of patterning, and sticking between the screen and substrate. The viscosity can be increased and controlled to improve printability through the use of polymer additives of various molecular weights. Such a polymer additive should meet several conditions: it should be soluble in a similar solvent as the electroluminescent polymer; it should be electrochemically inert in the chosen medium and operating conditions; it should have an electronic structure so that no significant charge transfer occurs from the electroluminescent polymer to the polymer additive; and it should have a sufficiently large band-gap so that the polymer additive does not significantly absorb the light emission from the electroluminescent polymer. Finally, the polymer additive should have a sufficiently high decomposition temperature that it remains as a solid in the electroluminescent polymer film after the solvent is removed by heating and/or applying a vacuum to the film. Polymers that can be used include ionic conducting materials such as homopolymers or copolymers having units of ethylene oxide, propylene oxide, dimethyl siloxane, oxymethylene, epichlorohydran, phosphazene, bis-(methoxyethoxyethoxy) phosphazene, oxetane, tetrahydrofuran, 1,3-dioxolane, ethylene imine, ethylene succinate, ethylene sulfide, propylene sulfide, oligo(oxyethlene)methacrylate, oligo(oxyethylene) oxymethylene, oligo(oxyethylene) cyclotriphosphaze, and mixtures thereof.

Multiple salts with different ionic sizes help to achieve a better balance of the ionic doping profile required to shift the recombination zone away from either interface, and therefore improve lifetime and efficiency. A combination of salts with different mobilities can also be used to achieve faster device turn on while maintaining the longer lifetimes frequently associated with more electrochemically stable and less mobile salts. Less mobile aromatic salts that have better compatibility to LEP and result in better luminescent efficiency can be combined with more mobile non-aromatic salts for faster turn-on. The selection of salts with a specific set of desired properties are divided into three groups:

### Group 1: Selecting Ionic Dopant Salt Combinations Based on Ionic Mobility

Salts that have smaller anions or cations tend to be more mobile than salts with bulky anions or cations. More mobile salts result in faster turn on speeds and lower initial operating voltages. Examples of salts with small anions include those with anions containing halides (fluorine, bromine, chlorine, and iodine), hexafluorophosphide (PF₆⁻), tetrafluoroborate (BF₄⁻), organoborates, thiocyanate, dicyanamide, alkylsulfates, tosylates, methanesulfonate, trifluoromethanesulfonate, bis(trifluoromethyl-sulfonyl)imide, tetracyanoborate, trifluoroacetate, tri(pentafluoroethyl) trifluorophosphate, bis[oxalate(2-)]borate, sulfamate, bis[1,2-benzenediolate (2-)-O,O′]borate and perchlorate (ClO₄⁻). Examples of salts with mobile cations include salts containing an alkali metal (such as lithium, sodium, potassium, rubidium, and cesium), a divalent metal (such as magnesium, calcium, strontium, and barium), nitrogen-based salts with small side chains (such as ammonium (NH₄⁺), tetramethylammonium (TMA⁺), tetraethylammonium (TEA⁺), tetrabutylammonium (TBA⁺), tetrapentylammounium (TPA⁺), tetrahexylammonium (THA⁺) tetraheptylammonium (THPA⁺)), aromatic nitrogen-based cations (derived from imidazole, pyridine, pyrrole, pyrazole, etc.), morpholium, piperidinium, phosphonium, sulfonium, and guanidinium. A salt selected for ionic mobility could have both a mobile cation and anion or a mixture of salts could be used to obtain a formulation containing high mobility cations and anions. Table 1 shows physical properties of some of the ionic dopant salts of interest here and used in the examples below.

TABLE 1

| | | | | Hydrolytic | Compatibility | Compatibility |
|---|---|---|---|---|---|---|
| | | Melting | | stability | with LEP | with LEP |
| | Molecular | point | Solubility in | for anion | aromatic | non-aromatic |
| Salts | Weight | (C.) | chlorobenzene | groups | backbone | side-chains |
| THAPF₆ | 500 | 135 | Yes at room | poor | Poor | good |
| | | | temp. | | | |
| TBATf | 391 | 112 | Yes at room | good | Poor | good |
| | | | temp. | | | |
| BzOAPF₆ | 545 | 89 | Yes at room | poor | good | good |
| | | | temp. | | | |
| THPABPh₄ | 730 | 142 | Yes at 80 C. | fair | good | good |

One useful parameter for comparing ionic dopant mobilities is molecular weight. As discussed earlier, it can be advantageous to combine more and less mobile ions to allow for fast turn on and low turn on voltage while still maintaining long overall luminance and voltage lifetimes. This can be a synergistic effect, because reducing voltages at turn on can avoid degradation of device materials and interfaces, leading to longer overall lifetime in addition to the generally advantageous lower voltage of operation itself. Dopant combinations with cation differences as small as 6% (tetraheptylammonium (THPA) cation vs. tribenzyl-n-octylammonium (BzOA)) based on the molecular weight of the smaller ion can be advantageous, whereas larger mass and size differences can be even more advantageous, such as the case for a tetrahexylammonium cation vs. tetrabutylammonium cation, which has a mass difference of ˜46% and a smaller cation of approximately 242 g/mol. This also extends to anions where anion size and molecular weight difference are also beneficial. Anion size difference for a dopant combination including trifluoromethanesulfonate and hexafluorophosphate has a molecular weight difference of ˜3% with a smaller anion molecular weight of approximately 145 g/mol. Combinations containing even smaller size and lower molecular weight molecular anions such as boron tetraflouride with a mass of ˜87 g/mol are also advantageous.

One useful measure for faster acting, higher effective mobility dopants is melting temperature. In particular, the inclusion of ionic dopants that can rapidly dissociate provides components that can move rapidly at initial ambient temperatures at turn on and at steady operating temperatures of devices (for example from −20 C to 85 C). Ionic salts that are liquid in these temperature ranges are sometimes generally termed “ionic liquids” which are more generally defined as salts whose melting point is relatively low (below 100 C). Dopant blend systems (binary, ternary, or quaternary) that contain at least one ionic dopant with a melting point below 100 C in combination with other higher melting point dopants can be particularly advantageous.

### Group 2: Selecting Salts for Ionic Stability

Salts that result in the greatest ionic mobility and lowest initial operating voltages may not be the most electrochemically stable. To improve lifetime, the anion or cation can be chosen for greater electrochemical stability. An example of an anion with greater stability is trifluoromethanesulfonate (CF₃SO₃⁻, also known as triflate (TF⁻)), bis(trifluoromethylsulphonyl)imide (TFSI⁻), and related anions containing triflate. The triflate anion is an extremely stable polyatomic ion, being the conjugate base of one of the strongest known acids, triflic acid. Example of cations with greater electrochemical stability include cyclic cations such pyrrolidinium and piperidinium, and aliphatic and nitrogen-containing cations, such as tetramethylammonium (TMA⁺), tetraethylammonium (TEA⁺), tetrabutylammonium (TBA⁺), tetrapentylammonium (TPA⁺), tetrahexylammonium (THA⁺), and tetraheptylammonium. A salt selected for stability can contain a more electrochemically stable cation and anion or a mixture of salts can be used to obtain new combinations of more stable cations and anions.

### Group 3: Selecting Salts for Polymer Compatibility

The aliphatic nature of many ionic dopants (for example, those including tetrahexylammonium hexafluorophosphate ions) can lead to issues with phase separation when added to a polymer containing an aromatic backbone. Improved compatibility can be achieved by adding salts containing aromatic anions or cations. Examples of aromatic cations are tribenzyl-n-octylammonium (BzOA⁺) and benzyltri(n-hexyl) ammonium. Examples of aromatic anions are tetraphenylborate (BPh₄⁻) and bis[1,2-benzeneddiobate (2-)-O,O′]borate. A salt selected for compatibility can contain an aromatic cation and anion or a mixture of salts could be used to obtain an aromatic cation and an aromatic anion.

Although it may be desirable to have certain total levels of ionic dopant concentrations for lower voltage and long lifetimes device operation, the maximum solubility of some useful ionic dopant salts, such as tetrabutylammonium and metal cations, may be of lower solubility in the ink solution or in the solid electrolyte-containing film. Therefore, it can be advantageous to combine amounts of less soluble but useful salts, such as those that may have high mobility, with additional salts which have a higher solubility, to reach a preferred overall total ionic dopant concentration. A high concentration may include weight ratios of dopant to light emitting polymer of more than 10% in some cases.

### Selection Rules for Optimizing Mixed Salt Combinations

In order to optimize performance, a mixture of salts should be chosen that contains some anions and/or cations with fast ionic mobility at low temperatures, some with greater electrochemical stability, and some with strong compatibility with aromatic polymers. This could include one or more salts from any two of the groups discussed above, and preferably salts from all three groups.

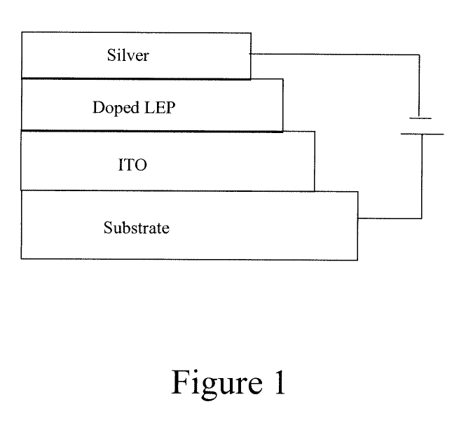

FIG. 1 is a diagram of a simplified polymer electroluminescent device. The device uses silver as the cathode 12, indium tin oxide (ITO) as the anode 14 over substrate 16, and doped LEP 18 containing a conjugated light-emitting polymer, an ionic conducting polymer, and salts.

### Example 1

### Single Salt-Based Ink Formulation

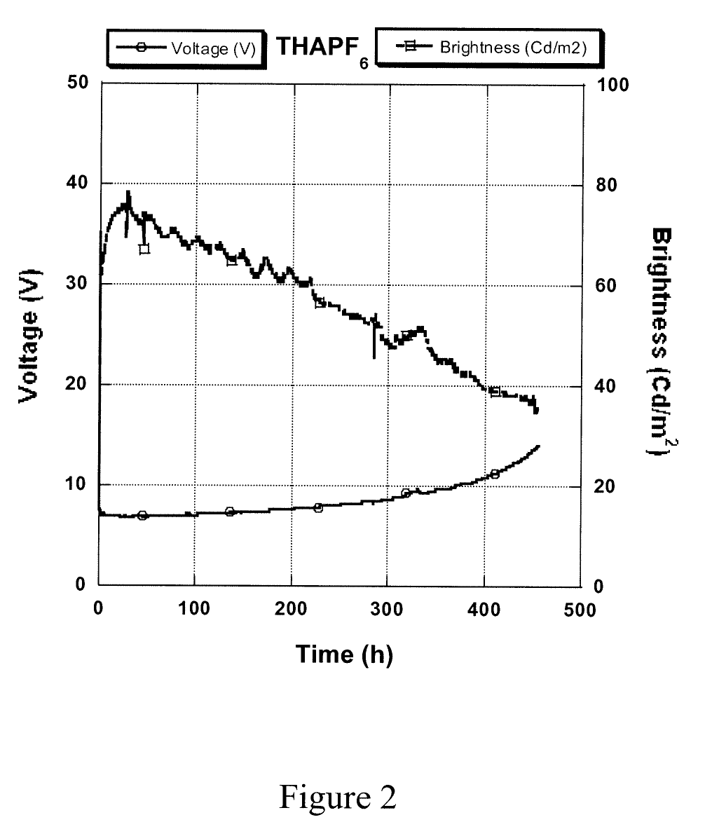

In a glove box filled with nitrogen, a polyphenylene vinylene (PPV) yellow polymer (0.045 g, MW 1 million, Merck), polyethyleneoxide (PEO) (0.018 g, MW 5 million, Polyscience), and tetrahexylammonium hexafluorophosphate (THAPF₆) (5.7 mg, Sigma-Aldrich) were mixed together in solvents of chlorobenzene (3 g) and m-xylene (4.5 g). After thoroughly mixing, the ink was transferred out from the glove box and screen-printed onto a pre-patterned indium tin oxide (ITO)-coated polyethylene terephthalate (PET) substrate with an active area of 1 cm². After removing the solvents by heating the substrate, the top electrode (Ag) from a silver paste was printed onto the luminescent polymer layer, to complete the device fabrication. The device was then transferred into a nitrogen glove box and tested under a constant current density at 2 mA/cm². Both photocurrent and voltage were recorded as function of time. This device had maximum luminescence brightness of 75 cd/m². FIG. 2 illustrates voltage and brightness as a function of time for the device of Example 1 under 2 mA/cm² current density.

### Example 2

### Binary Salt-Based Ink Formulation

### First Formulation

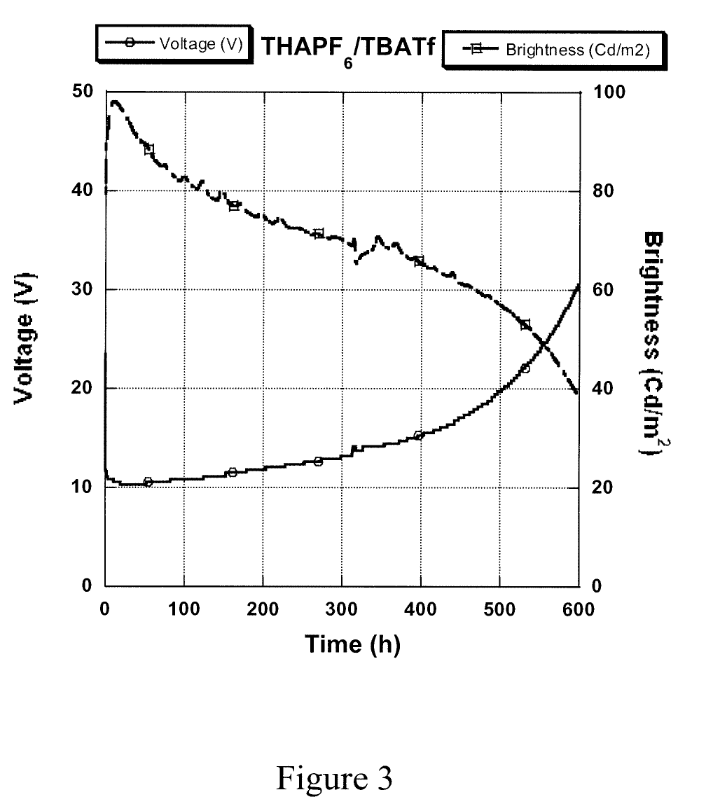

This ink was formulated in a similar way as described above for Example 1, using a mixture of tetrabutylammonium trifluoromethanesulfonate (TBATf) and THAPF₆. Under a constant current density at 2 mA/cm², its printed device had a maximum luminescence at 84 cd/m² (FIG. 3).

### Example 3

### Binary Salt-Based Ink Formulation

### Second Formulation

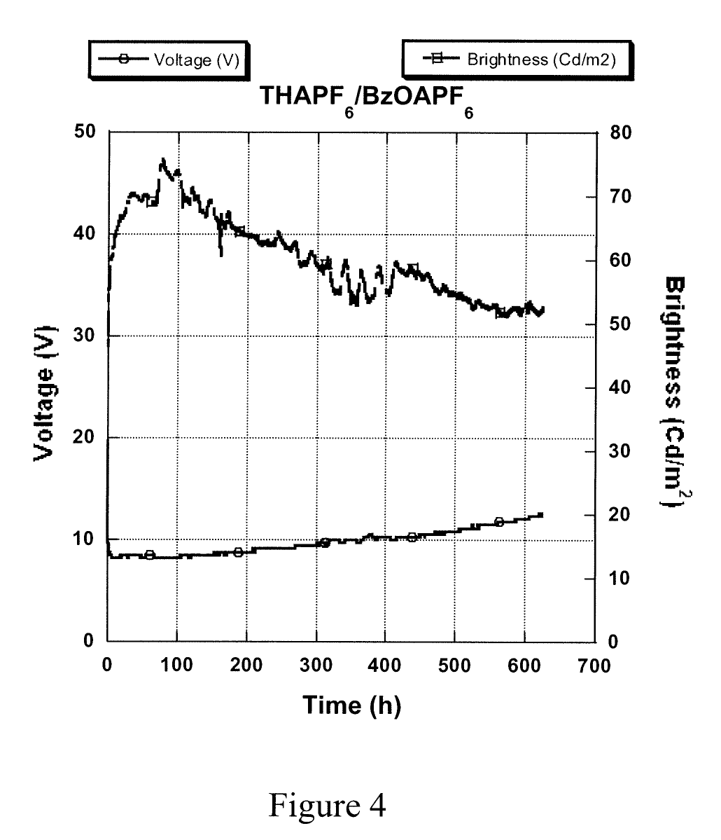

This ink was formulated in a similar way as described above for Example 1, using a mixture of THAPF₆ and tribenzyl-n-octylammonium hexafluorophosphate (BzOAPF₆). Under a constant current density at 2 mA/cm², its printed device had a maximum luminescence at 78 cd/m² (FIG. 4).

### Example 4

### Ternary Salt-Based Ink Formulation

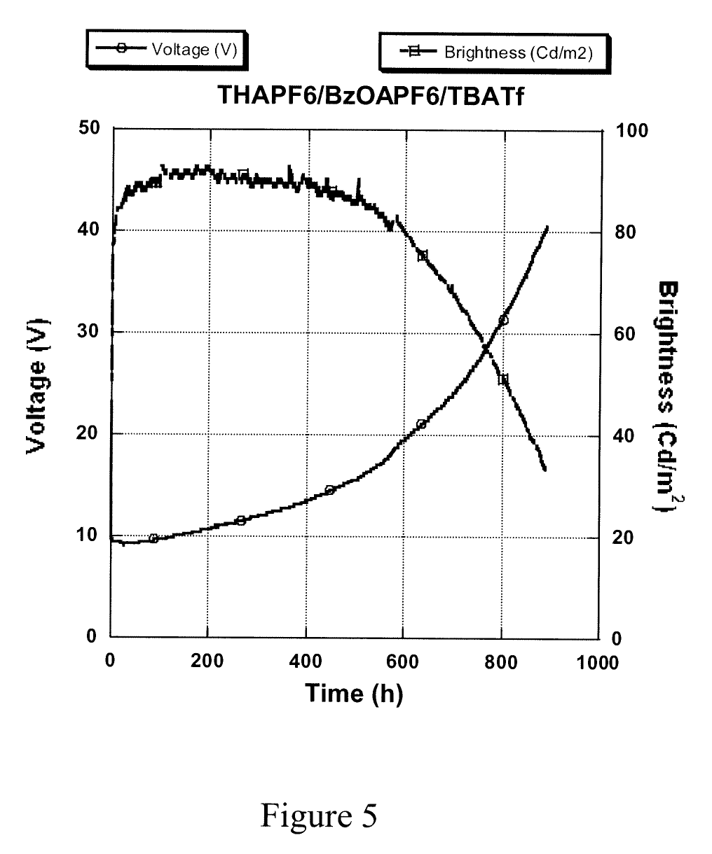

This ink was formulated in a similar way as described above for Example 1, using a mixture of TBATf, THAPF₆ and tribenzyl-n-octylammonium hexafluorophosphate (BzOAPF₆). Under a constant current density at 2 mA/cm², its printed device had a maximum luminescence at 94 cd/m² (FIG. 5).

### Example 5

### Quaternary Salt-Based Ink Formulation

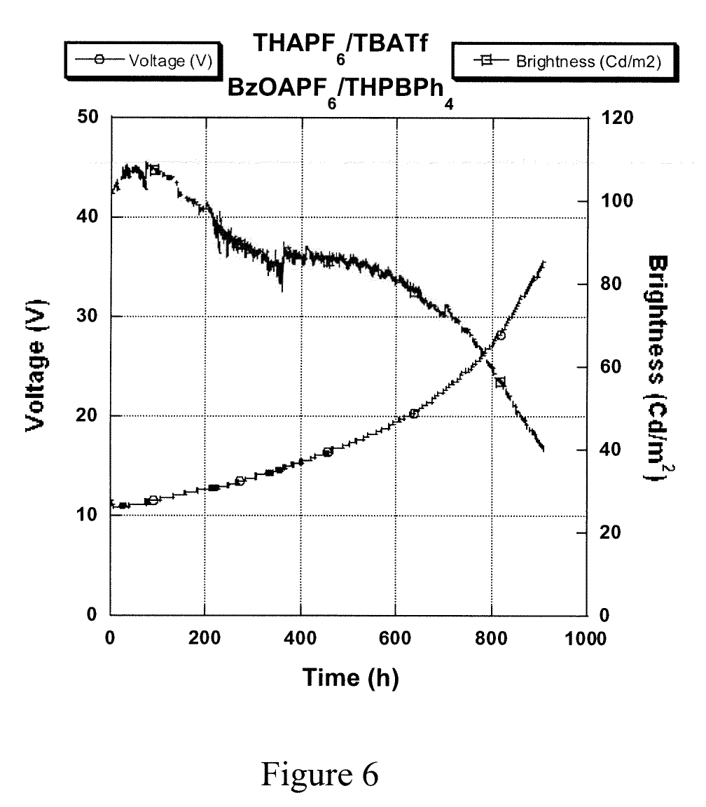

This ink was formulated in a similar way as described above for Example 1, using a mixture of TBATf, THAPF₆, BzOAPF₆, and tetraheptylammonium tetraphenylborate (THPABPh₄). Under a constant current density at 2 mA/cm², its printed device had a maximum luminescence at 108 cd/m² (FIG. 6).

Table 2 provides a summary of the printed device data with the different ionic dopant salt mixtures discussed in Examples 1-6, which contain a range of thermal properties, mobilities and intercompatibility tendencies with transport and light emitting polymers. In Table 2 the lifetime at maximum brightness is converted to lifetimes at 100 cd/m² using an extrapolation t_{1/2}×(Lmax/100)^{y}, where t_{1/2} is the time to half maximum luminance, Lmax is the maximum brightness, and y is an exponent generally varying from 1.2 to 2.1. For these devices, the factor is 1.8.

TABLE 2

| | | | Luminance | Lifetime |
|---|---|---|---|---|
| Exam- | | Lmax | Efficiency | (h) for |
| ple | Salt(s) | (Cd/m²) | (Cd/A) | 100 Cd/m² |
| 1 | THAPF₆ | 75 | 3.75 | 260 |
| 2 | THAPF₆/TBATf | 98 | 4.90 | 530 |
| 3 | THAPF₆/BzOAPF₆ | 78 | 3.75 | .>600 |
| 4 | THAPF₆/TBATf/ | 94 | 4.70 | 730 |
| | BzOAPF₆ | | | |
| 5 | THAPF₆/TBATf/ | 108 | 5.40 | 950 |
| | BzOAPF6/THPABPh₄ | | | |

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A printable electroluminescent ink comprising:
(a) an electroluminescent organic material;
(b) a plurality of salts, each salt including a cation and an anion, wherein the plurality of salts provides at least two cations or two anions, and (i) a first cation or anion is selected from the group consisting of cations with a molecular weight of less than 250 g/mol and anions with a molecular weight of less than 150 g/mol, and (ii) a second cation or anion is selected from the group consisting of cations having a molecular weight at least five percent more than the first cation and anions having a molecular weight at least two percent more than the molecular weight of the first anion;
(c) an organic solvent; and
(d) an ionic conducting material.

2. The ink of claim 1 wherein the molecular weight of the second cation is at least 40% more than the molecular weight of the first cation.

3. The ink of claim 1 wherein the molecular weight of the second anion is at least 60% more than the molecular weight of the first anion.

4. The ink of claim 1 wherein the melting point of at least one of the salts is less than 100 C.

5. The ink of claim 4 wherein the melting point of at least one of the salts is less than 85 C.

6. The ink of claim 5 wherein the melting point of at least one of the salts is less than 25 C.

7. The ink of claim 1 wherein the first anion has a molecular weight of less than 90 g/mol.

8. The ink of claim 1 wherein at least one cation is selected from the group consisting of lithium, cesium, calcium, strontium, barium, rubidium, magnesium, sodium, potassium, imidazolium, pyridinium, pyrrolidinium, pyrazolium, pyrazole, phosphonium, ammonium, guanidinium, uranium, thiouronium, sulfonium, ammonium, tetramethylammonium, tetraethylammonium, tetrabutylammonium, tetrapentylammounium, tetrahexylammonium tetraheptylammonium, morpholinum, and piperidinium.

9. The ink of claim 1 wherein at least one anion is selected from the group consisting of alkylsulfates, tosylates, methanesulfonate, trifluoromethanesulfonate, bis(trifluoromethylsulfonyl)imide, hexafluorophosphide, tetrafluoroborate, organoborates, thiocyanate, dicyanamide, perchlorate, tetracyanoborate, trifluoro acetate, tri(pentafluoroethyl) trifluorophosphate, bis[oxalate(2-)]borate, sulfamate, bis[1,2-benzenediolate (2-)-O,O′]borate, and halides.

10. The ink of claim 1, wherein at least one cation or anion includes an aromatic group.

11. The ink of claim 1, where the organic solvent is o-xylene, m-xylene, p-xylene, chlorobenzene, dichlorobenzene, toluene, anisole, cyclohexanone, cyclopentanone, cumene, tetrahydrofuran, dioxane, methyl benzoate, methyl anisole, acetonitorile, chloroform, trichlorobenzene, dimethylformamide, dimethylsufoxide, N-methylpyrrolidone, or a mixture thereof.

12. The ink of claim 1, wherein the soluble electroluminescent organic material is a conjugated polymer.

13. The ink of claim 12, wherein the conjugated polymer material includes polyfluorene, polyvinyl carbazole, polythiophene, polyphenylene, polyanthracene, polythiophene, polyspiro, polycarbazole, polyphenylene vinylene, polybenzocarbazole, polyphenylene ethynylene, or polybenzothiophene groups.

14. The ink of claim 1, wherein the ionic conducting material includes a polymer with units selected from the group consisting of ethylene oxide, propylene oxide, dimethyl siloxane, oxymethylene, epichlorohydran, phosphazene, bis-(methoxyethoxyethoxy) phosphazene, oxetane, tetrahydrofuran, 1,3-dioxolane, ethylene imine, ethylene succinate, ethylene sulfide, propylene sulfide, oligo(oxyethlene)methacrylate, oligo(oxyethylene)oxymethylene, and oligo(oxyethylene)cyclotriphosphaze.

15. The ink of claim 1, wherein the soluble electroluminescent organic material is an organic chromophore imbedded in a charge transporting polymer.

16. The ink of claim 1, wherein the soluble electroluminescent organic material contains a phosphorescent metal complex.

17. A printable electroluminescent ink comprising:
(a) a soluble electroluminescent organic material;
(b) a plurality of salts, each salt including a cation and an anion, wherein the melting point of a first salt is less than 100 C and the melting point of a second salt is greater than 100 C, and the melting points of the first and second salts differ by at least 10 C;
(c) an organic solvent; and
(d) an ionic conducting material.

18. The ink of claim 17 wherein the salts have at least a first cation and a second cation, and the molecular weight of the second cation is at least 40% more than the molecular weight of the first cation.

19. The ink of claim 17 wherein the salts have at least a first anion and a second anion, and the molecular weight of the second anion is at least 60% more than the molecular weight of the first anion.

20. The ink of claim 17 wherein the melting point of at least one of the salts is less than 100 C.

21. The ink of claim 20 wherein the melting point of at least one of the salts is less than 85 C.

22. The ink of claim 21 wherein the melting point of at least one of the salts is less than 25 C.

23. The ink of claim 17 wherein the first anion has a molecular weight of less than 90 g/mol.

24. The ink of claim 17 wherein at least one cation is selected from the group consisting of lithium, cesium, calcium, strontium, barium, rubidium, magnesium, sodium, potassium, imidazolium, pyridinium, pyrrolidinium, pyrazolium, pyrazole, phosphonium, ammonium, guanidinium, uranium, thiouronium, sulfonium, ammonium, tetramethylammonium, tetraethylammonium, tetrabutylammonium, tetrapentylammounium, tetrahexylammonium, tetraheptylammonium, morpholinium, and piperidinium.

25. The ink of claim 17 wherein at least one anion is selected from the group consisting of alkylsulfates, tosylates, methanesulfonate, trifluoromethanesulfonate, bis(trifluoromethylsulfonyl)imide, hexafluorophosphide, tetrafluoroborate, organoborates, thiocyanate, dicyanamide, perchlorate, tetrafluoroborate, organoborates, thiocyanate, dicyanamide, perchlorate, tetracyanoborate, trifluoroacetate, tri(pentafluoroethyl) trifluorophosphate, bis[oxalate(2-)]borate, sulfamate, bis[1,2-benzenediolate (2-)-O,O′]borate, and halides.

26. The ink of claim 17, wherein at least one cation or anion includes an aromatic group.

27. The ink of claim 17, where the organic solvent is o-xylene, m-xylene, p-xylene, chlorobenzene, dichlorobenzene, toluene, anisole, cyclohexanone, cyclopentanone, cumene, tetrahydrofuran, dioxane, methyl benzoate, methyl anisole, acetonitorile, chloroform, trichlorobenzene, dimethylformamide, dimethylsufoxide, N-methylpyrrolidone, or a mixture thereof.

28. The ink of claim 17, wherein the soluble electroluminescent organic material is a conjugated polymer.

29. The ink of claim 28, wherein the conjugated polymer material includes polyfluorene, polyvinyl carbazole, polythiophene, polyphenylene, polyanthracene, polythiophene, polyspiro, polycarbazole, polyphenylene vinylene, polybenzocarbazole, polyphenylene ethynylene, or polybenzothiophene groups.

30. The ink of claim 17, wherein the ionic conducting material includes a polymer with units selected from the group consisting of ethylene oxide, propylene oxide, dimethyl siloxane, oxymethylene, epichlorohydran, phosphazene, bis-(methoxyethoxyethoxy) phosphazene, oxetane, tetrahydrofuran, 1,3-dioxolane, ethylene imine, ethylene succinate, ethylene sulfide, propylene sulfide, oligo(oxyethlene)methacrylate, oligo(oxyethylene)oxymethylene, and oligo(oxyethylene)cyclotriphosphaze.

31. The ink of claim 17, wherein the soluble electroluminescent organic material is an organic chromophore imbedded in a charge transporting polymer.

32. The ink of claim 17, wherein the soluble electroluminescent organic material contains a phosphorescent metal complex.

33. A printable electroluminescent ink comprising:
(a) an electroluminescent organic material;
(b) an organic solvent;
(c) an ionic conducting material; and
(d) a plurality of salts, each salt containing a cation and an anion, wherein the plurality of salts provides members from at least two of the groups consisting of:
(i) a first group consisting of cations containing an alkali metal, a divalent metal, an ammonium group, an alkyl ammonium group, a cyclic carbon group, or a nitrogen-containing group;
(ii) a second group consisting of anions containing a trifluoromethyl group, a sulfur group, or an inorganic group containing a halide; and
(iii) a third group consisting of cations and anions containing an aromatic group.

34. The ink of claim 33, including two cations differing in molecular weight by more than five percent based on the molecular weight of the smaller cation.

35. The ink of claim 34, wherein the two cations differ in molecular weight by more than 40% based on the molecular weight of the smaller cation.

36. The ink of claim 33, including two anions differing in molecular weight by more than two percent based on the molecular weight of the smaller anion.

37. The ink of claim 36, wherein the two anions differ in molecular weight by more than 60% based on the molecular weight of the smaller anion.

38. The ink of claim 33, wherein the melting point of at least one of the salts is less than 100C.

39. The ink of claim 38, wherein the melting point of at least one of the salts is less than 85C.

40. The ink of claim 39, wherein the melting point of at least one of the salts is less than 25C.

41. The ink of claim 33, wherein the melting points of two of the salts differ by at least 10C.

42. The ink of claim 33, wherein at least one cation has a molecular weight of less than 250 g/mol.

43. The ink of claim 33, wherein at least one anion has a molecular weight of less than 150 g/mol.

44. The ink of claim 43, wherein at least one anion has a molecular weight of less than 90 g/mol.

45. The ink of claim 33, wherein the anion from the second group is selected from the group consisting of hexafluorophosphide, tetrafluoroboride, and perchlorate.

46. The ink of claim 33, wherein the cation from the first group is selected from the group consisting of ammonium tetramethylammonium, tetraethylammonium, tetrabutylammonium, tetrapentylammonium, tetrahexylammonium (THA⁺), and tetraheptylammonium.

47. The ink of claim 33, wherein the anion from the second group is selected from the group consisting of methanesulfonate, trifluoromethanesulfonate, and bis(trifluoromethylsulphonyl)imide.

48. The ink of claim 33, wherein the cation or anion from the third group is selected from the group consisting of tribenzyl-n-octylammonium and tetraphenylborate.

49. The ink of claim 33, where the organic solvent is o-xylene, m-xylene, p-xylene, chlorobenzene, dichlorobenzene, toluene, anisole, cyclohexanone, cyclopentanone, cumene, tetrahydrofuran, dioxane, methyl benzoate, methyl anisole, acetonitorile, chloroform, trichlorobenzene, dimethylformamide, dimethylsufoxide, N-methylpyrrolidone, or a mixture thereof.

50. The ink of claim 33, wherein the soluble electroluminescent organic material is a conjugated polymer.

51. The ink of claim 50, wherein the conjugated polymer material includes polyfluorene, polyvinyl carbazole, polythiophene, polyphenylene, polyanthracene, polythiophene, polyspiro, polycarbazole, polyphenylene vinylene, polybenzocarbazole, polyphenylene ethynylene or polybenzothiophene groups.

52. The ink of claim 33, wherein the ionic conducting material includes a polymer with units selected from the group consisting of ethylene oxide, propylene oxide, dimethyl siloxane, oxymethylene, epichlorohydran, phosphazene, bis-(methoxyethoxyethoxy) phosphazene, oxetane, tetrahydrofuran, 1,3-dioxolane, ethylene imine, ethylene succinate, ethylene sulfide, propylene sulfide, oligo(oxyethlene)methacrylate, oligo(oxyethylene)oxymethylene, and oligo(oxyethylene)cyclotriphosphaze.

53. The ink of claim 33, wherein the soluble electroluminescent organic material is an organic chromophore imbedded in a charge transporting polymer.

54. The ink of claim 33, wherein the soluble electroluminescent organic material contains a phosphorescent metal complex.
